(19) United States
(12) Patent Application Publication
(10) Pub. No.: US 2013/0054874 A1
(43) Pub. Date: Feb. 28, 2013

(54) UPDATING COMPUTER READABLE INSTRUCTIONS ON DEVICES IN A DATA STORAGE FABRIC

(71) Applicants: Michael G. Myrah, Cypress, TX (US); Balaji Natrajan, Spring, TX (US); Sohail Hameed, Houston, TX (US)

(72) Inventors: Michael G. Myrah, Cypress, TX (US); Balaji Natrajan, Spring, TX (US); Sohail Hameed, Houston, TX (US)

(21) Appl. No.: 13/220,272

(22) Filed: Aug. 29, 2011

(51) Int. Cl. G06F 12/02

(52) U.S. Cl. 711/103; 711/E12.008

(57) ABSTRACT

Updating computer readable instructions on devices in a data storage fabric is disclosed. A zone manager virtual PHY is established and an active device is granted control over the devices in the data storage fabric. The devices include in-band communication with the zone manager virtual PHY. The zone manager virtual PHY flashes an image of the computer readable instructions over in-band communication to the devices through in-band communication with the active device.

### BACKGROUND

In data storage technology, Small Computer System Interface, or SCSI, is a set of standards for physically connecting and transferring data between computers and peripheral devices. The SCSI standards define commands, protocols, and electrical and optical interfaces. SCSI is most commonly used for hard disks and tape drives, but it can connect a wide range of other devices, including scanners and compact disc drives. The SCSI standard defines command sets for specific peripheral device types; the presence of “unknown” as one of these types means it can be used as an interface to almost any device, but the standard is highly pragmatic and addressed toward commercial requirements such as Redundant Array of Independent Disks, or RAID.

Since the public introduction of SCSI in 1981, there have been no less than seven generations of the parallel SCSI protocol. Each generation doubled the bandwidth of the previous one, primarily by doubling the bus clock frequency. But as the bus frequency was increased with each new generation, so did the negative impact of bus contention, signal degradation, and signal skew, i.e., slight signal delays from one wire trace to the next. After the development of Ultra320 SCSI standard with a bandwidth of 320 MB/s per channel, further bandwidth improvements to parallel SCSI could not occur without developing new and expensive technologies.

Serial Attached SCSI, commonly referred to as SAS, is a relatively recently-developed computer bus used to move data to and from computer storage devices. SAS was later transferred to the InterNational Committee for Information Technology Standards (INCITS) T10 to become an American National Standards Institute, or ANSI, and International Organization for Standardization/International Electrotechnical Commission, or ISO/IEC, standard. SAS uses a point-to-point serial protocol that replaces the parallel SCSI bus technology in data centers and workstations. SAS applies the command set from parallel SCSI, frame formats and full duplex communication of Fibre Channel. Also, SAS uses the Serial Advanced Technology Attachment, often abbreviated Serial ATA or simply SATA, interface for compatibility and investment protection. The SAS architecture addresses the parallel SCSI problems of bus contention, clock skew, and signal degradation at higher signaling rates, and can provide performance headroom in enterprise storage applications over SCSI.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating an example of a computing device.

FIG. 2 is a schematic diagram illustrating an example of an SAS fabric that can be configured to employ computing devices such as the computing device of FIG. 1.

FIG. 3 is a block diagram illustrating an example of a method for updating or overwriting computing devices in the SAS fabric of FIG. 2.

FIG. 4 is a block diagram illustrating an example method that can be configured for use in the method of FIG. 3.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various exemplary embodiments described herein may be combined with each other, unless specifically noted otherwise.

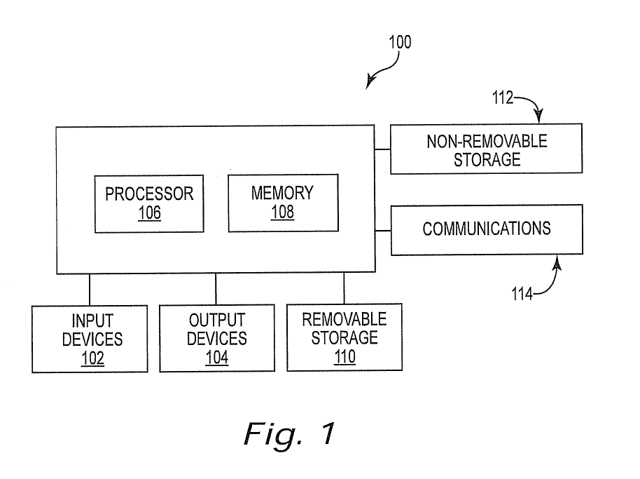

FIG. 1 illustrates an embodiment of a computer system that can be employed in an SAS operating environment and includes a computing device 100. In one example, the computing device 100 can include or can be coupled to one or more input devices 102, such as keyboard, pointing device (e.g., mouse), voice input device, touch input device, or the like. Computing device 100 can also include one or more communication connections 114 that allow the computing device 100 to communicate with other computing devices/applications. Computing device 100 can also include or can be coupled one or more output devices 104, such as a display, printer, or the like. In a basic configuration, computing device 100 typically includes a processor architecture having at least one processing unit, i.e., processor 106, and memory 108. Depending on the configuration and type of computing device, memory 106 may be volatile, non-volatile, or some combination of the two. The memory 108 can be arranged in a memory hierarchy such as a cache. Computing device 100 can also include additional storage including, but not limited to, magnetic or optical disks or solid state memory, or flash storage devices such as removable storage 110 and non-removable storage 112 for storage of information such as computer readable instructions, data structures, program modules or other data. The computing device 100 can be configured to run computer readable instructions such as firmware and an operating system software program that can be stored on the storage media or memory as well as one or more software applications, which make up a system platform.

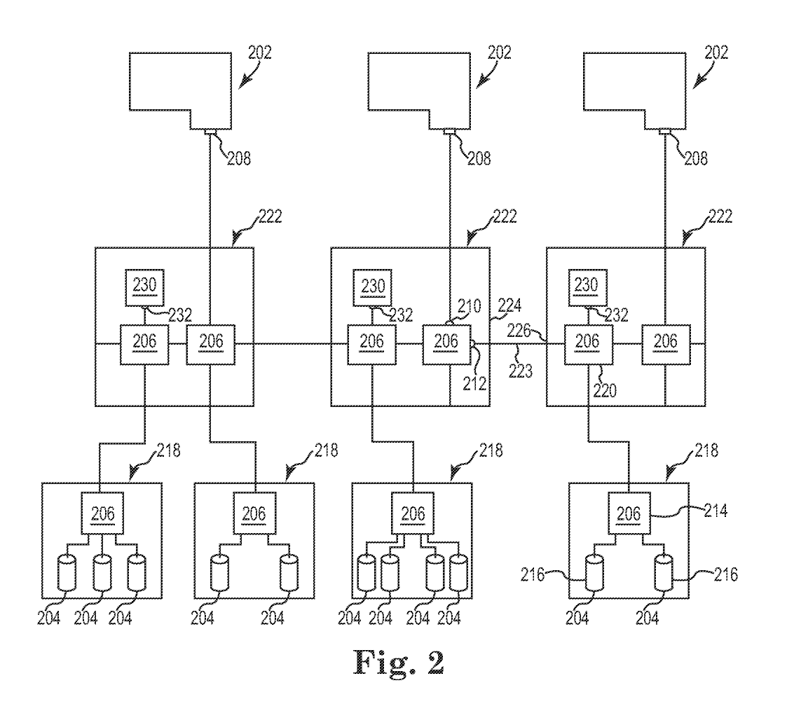

FIG. 2 illustrates an example SAS fabric, or SAS domain 200. SAS is a point-to-point architecture that transfers data to and from SCSI storage devices by using serial communication. In general, an SAS domain is an input/output (I/O) system having a set of SAS devices that communicate with one another by means of a service delivery subsystem. The SAS domain 200, use to achieve reliable, high-speed serial communication, in general includes initiators 202, targets 204, and expanders 206. Each SAS device has a unique worldwide name, or SAS address, which identifies of an initiator port, a target port, or an expander device, assigned at manufacturing to simplify its identification in a domain.

The initiator 202 is a host bus adaptor (HBA), or controller, that at times may be a stand-alone device or can be included as a component in the computing device 100. The initiator 202 is attached to one or more targets 204, such as SAS hard disk drives, SATA hard disk drives, and SAS tape drives, to form an SAS domain. An initiator 202 often includes one or more of Serial SCSI Protocol (SSP) ports typically used to communicate with SAS drives, Serial ATA Tunneling Protocol (STP) ports typically used to communicate with SATA drives, and/or Serial Management Protocol (SMP) ports typically used to communicate with expanders 206 in an SAS domain.

An SAS initiator 202 typically includes multiple ports 208 for connection to internal targets, external targets, such as targets 204, or both. An internal target can include, for example, a RAID system including SAS or SATA drives included within the computing device 100, which can include a server. Each initiator port can have a single physical link, which can be referred to as a narrow port, or 2, 4, 8 or more physical links, which can be referred to as a wide port and are described below. SAS initiator ports can be connected to separate domains for fail-over redundancy. SAS hard drives (such as enterprise-class and midline devices) can have two narrow ports. Each port can reside in a different SAS domain to provide fail-over redundancy and load balancing. SAS hard drives leverage a common electrical and physical connection interface with SATA hard drives. However, SATA hard drives, including solid-state drives, can have a single narrow port.

A PHY is an object in a device that is used to interface to other devices. A physical PHY is a PHY that includes a transceiver and electrically interfaces to a physical link to communicate with another physical PHY. A virtual PHY is a PHY that interfaces with a vendor-specific interface to another virtual PHY inside the same device. A PHY is a mechanism that contains a transceiver that electrically interfaces to a physical link. In one example, a physical link includes two differential signal pairs, one pair in each direction, to connect together two physical PHYs. A wide port includes more than one PHY, and a wide link is a group of physical links that attaches a wide port to another wide port. In the example fabric 200, PHYs are included in the disk drive bays, rather than the drives themselves, as the drives can be easily interchanged.

Expanders 206 scale the number of targets 204 attached to an initiator 202, thereby creating a larger SAS domain 200. Expanders 206 establish connections between initiators 202, targets 204, and other expanders 206 by receiving commands and data in one port, such as a port 210 proximal to the initiator 202, and routing them to another port, such as port 212 distal to the initiator 202, based on the SAS address of the target 204. In some examples, an expander 214 includes a port distal to the initiator 202 directly coupled to a target 216, such as within a storage enclosure 218 and can be referred to here as an enclosure expander 214. The storage enclosure 218 can include multiple targets 204 and a storage enclosure processing system in addition to the enclosure expander 214. In other examples, expanders 220 include a port distal to the initiators 202 directly coupled to another expander 206. and can be referred to here as a switch expander 220. One or more switch expanders 220 can be included in a device that is often referred to as a switch 222. Typically, a switch can also include a switch processing system. Switches 222, as well as storage enclosures 218, can often be accessed by another network, such as an Ethernet, through a sideband interface (not shown) in addition to the SAS fabric 200. In the illustrated example, initiators 202 are coupled to switches 222 that are coupled to an enclosure expander 214 that is coupled to target 216 within a storage enclosure 218 through the SAS fabric 200. Other topologies are contemplated.

Expanders 206 use three routing methods—direct, table, and subtractive. An expander, such as enclosure expander 214, uses direct routing to forward commands and data to targets 216 directly attached to the enclosure expander 214 in the illustrated example. Switches 222 can also use table routing to forward commands and data to another expander 206, such as one within a storage enclosure 218 or to another switch 222. Table routing is used for identifying devices connected to the expanders connected to a device's own PHY. When an expander 206 receives an address that it does not recognize, it uses subtractive routing to forward the commands and data to another expander 206 that does recognize the address.

Many storage networks can be implemented with just a set of typical SAS switches 222 (such as 16 ports as currently used), but there are some larger customers that would prefer to have double or triple the amounts of ports as typical switch expander 220. To meet the demands of large storage networks, two or more typical switches 222 can be trunked together at connection 223, or formed as a daisy chain, to enlarge the SAS fabric 200. In one example, a switch 224 proximate to an initiator 202 can have a port distal to the initiator 202 coupled to another switch 226 at a port proximal to the initiator 202. Trunking can continue in this manner until the SAS fabric 200 is configured to meet the demands of the user. SAS fabrics 200 can be initially configured with trunked switches 222, switches 222 can be later trunked to incrementally scale the network, or a combination of the two.

The number of SAS devices in a given domain 200 is limited only by the size of the expander routing tables, but managing a large number of devices can be complicated. Zoning is a management tool included in the SAS standard, such as SAS-2 and above, to provide for traffic management and security. Second-generation SAS (SAS-2) link speed doubles the physical link rate to 6.0 Gb/s. SAS-2 eliminates the distinction between fanout and edge expanders with self-configuring expanders. SAS-2 is backward compatible with SAS-1. SAS-2 also enables zoning for enhanced resource deployment flexibility, security, and data traffic management.

Through the use of zoning, large physical topologies can be broken into logical groups such as zone groups, which are a set of PHY s in a zone that all have the same access permission. A group of zoning-enabled expanders that cooperate to control access between PHYs is known as a zoned portion of a service delivery system (ZPSDS). Examples of zoning include 128 or 256 zone groups numbered from 0 to 127 or 0 to 255, respectively. Zone groups 0 through 8 are pre-defined in the SAS standard. Devices in zone group 0 can only access devices in zone group 1, while devices in zone group 1 are allowed access to all zone groups. For example, a system administrator can use zone group 0 for a new (unassigned) device that is added to a ZPSDS. The administrator can also use zone group 1 for topology discovery and zone management. In one example, one ZPSDS is created per fabric 200.

Permission tables in SAS expanders 206 control zoning. An end device, such as target 204, does not require any special features to operate within a zoned SAS domain, which makes legacy SAS and SATA devices compatible. An end device in a zone can interface with other end devices in the domain as permitted by the zoning expander. The SAS-2 standard permits zoning, a secure zoning method that uses the unique identifier (ID) number of each expander PHY. In zoning, each port of a zoning expander is assigned to a zone group, and any device attached to one of the ports becomes part of that respective zone group. Devices within a zone group can interact with each other. The permission table in the expander controls access between devices in different zone groups. If an attached device changes, the expander may be configured to set the zone group to 0, or no access, which allows an address-resolved-like policy to be implemented. For example, if a particular SAS device address includes certain permissions and the device is moved to a different expander in the fabric, then the zone manager can reprogram the zone group at the new location.

A zone manager 230 is responsible for configuring each zone. The zone manager 230 can control a zone by using an end device that has an SAS port connected to one of the zoning expanders. The zone manager 230 can also control a zone through a sideband interface (such as Ethernet) on one or more expanders 206. The zone manager 230 assigns zone groups to all zoning expander PHYs, and it assigns all PHYs in a wide port to the same zone group. The zone manager 230 stores the zoning assignment of each expander PHY along with SAS addresses in the zoning expander's route table. Inside a particular ZPSDS, the zone manager assigns each zoning expander PHY attached to another zoning expander PHY to zone group 1. PHYs in zone group 1 have access to PHYs in all zone groups. The zone manager 230 assigns each zoning expander PHY on the boundary of the ZPSDS to a zone group other than group 1. The ZPSDS boundary is defined by designating expander PHYs as “not trusted” when connected to end devices outside the zone. Each zoning expander device also contains a zone permission table that controls whether a connection is allowed between PHYs in different zone groups.

In a typical example, a zone manager includes a computing device 100 and a zone manager application, which typically are not part of an SAS device by itself. As it is not an SAS device and is coupled to other SAS devices via Ethernet interfaces, this kind of zone manager typically cannot be discovered by any of the SAS devices of the domain 200 or by other zone managers running on other switches. Thus, for these kinds of zone managers to see each other SAS devices and arbitrate, they communicate out-of-band, such as over the Ethernet instead of over the SAS fabric 200, with proprietary protocols instead of standard SAS protocols. Out-of-band communication can be contrasted with in-band communication over the SAS fabric 200 with standard SAS protocols. For example, a zone manager with the task of updating firmware on the SAS devices typically performs this task over the Ethernet or in another out-of-band manner.

As briefly mentioned above, computing devices 100, such as SAS devices, can include firmware as well as other software. From time to time, newer versions of the firmware can be made available that contain updates, enhanced, features, new features, and bug fixes. In one example, a domain can benefit from having SAS devices include firmware with the same or similar features as other SAS devices. It could also be desirable to include new devices into an existing domain with firmware having the same or similar features as other SAS devices. Typically, the firmware is stored in a chip on the motherboard rather than a hard drive. It is possible to install newer firmware versions and upgrade, but the process is often different from upgrading the other software installed on a computing device. A flash utility is often used to upgrade or overwrite firmware on the chip. The process of performing the upgrade is called “flashing.”

Difficulties arise when a zone manager attempts to flash SAS devices over the Ethernet. For example, flashing is limited to SAS devices on the network. In some cases, SAS devices in a domain are included in separate and non-overlapping networks. Further, some SAS devices are not connected to the Ethernet. Thus, it can be difficult to maintain consistent versions of firmware over passive SAS devices. Connecting all of the SAS devices to a network or to the same network, however, can create undesirable limitations on the scalability of the fabric.

In the illustrated example, a zone manager 230 is implemented as a virtual PHY—a Zone Manager Virtual PHY (ZMVP) 232—on the switches 222. In one application, switches can use the ZMVP 232 to discover each other and grant SAS fabric control to a single active SAS switch 222 of a large topology. In one example, the active switch is responsible for executing zoning commands and maintaining zoning tables. The zone manager 230 attached to a ZMVP 232 would publish itself as both a SSP target and a SSP and SMP initiator and establish active and passive roles. In one respect, the ZMVP 232 is used for discovery and zoning commands, e.g., SMP Commands. A ZMVP 232 also exposes the SAS zone managers 230 on the SAS fabric 200 so that SAS switches 222 can communicate with other devices on the SAS fabric 200 without having to develop complex out-of-band communication protocols, such as SAS over Ethernet.

This configuration allows the ZMVP 232 to be used as a target device to flash firmware images in-band onto the SAS switches 222 of the fabric 200. By using a ZMVP 232 as a means of in-band flashing SAS switches 222, standard techniques can be used to flash one switch 222, i.e., an active switch, and have the active switch flash all other switches 222 in-band. The active switch can also flash a replacement switch once a firmware mismatch is detected. In one example, this can be automatically performed as soon as the replacement switch is inserted into the SAS fabric.

Accordingly, all of the switches 222 in the fabric can be flashed regardless of whether the switches 222 are all connected to the same out-of-band network and without complex protocols typically used to accomplish the same functionality out-of-band using SAS over Ethernet or other protocols. SAS based in-band flashing can use existing discovery and command functionality typically would not include an additional layer of software as in out-of-band Ethernet-based mechanisms thus reducing development and maintenance. Further, in-band flashing can be used to flash trunked switches and reduce difficulties in scaling SAS fabrics.

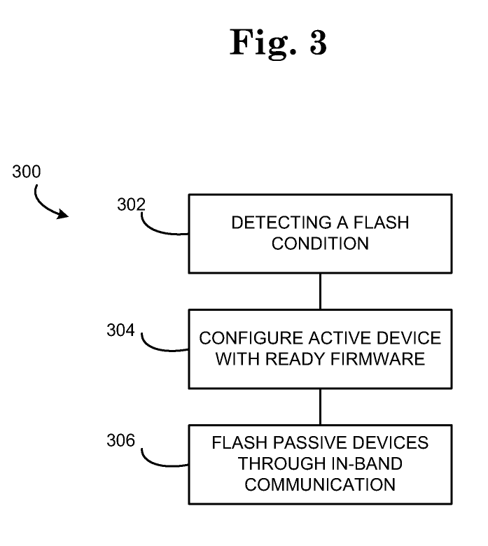

FIG. 3 illustrates an example method 300 of using a ZMVP 232 to flash the switches 222 of an SAS fabric where the switches 222 are connected to the ZVMP 232 through in-band communication. A flash condition is initiated, which is detected such as by the ZVMP at 302. In one example, a flash condition can include an indication that a firmware update is available for devices on the SAS fabric. Another flash condition can include the detection of a firmware mismatch or inconsistency between a passive switch and the active switch. For example, the passive switch could be a replacement switch that has not been used in the fabric or not used since the latest firmware update. The ZVMP configures an active switch through in-band communication to include a ready firmware at 304. The ready firmware is often an up-to-date version of the firmware. In some examples, the ready firmware is a new version of the firmware intended for SAS devices. In other examples, the ready firmware is a standard firmware currently being used on the SAS devices in the SAS fabric. The active switch in-band flashes a target passive switch (or target passive switches) with the ready firmware at 306.

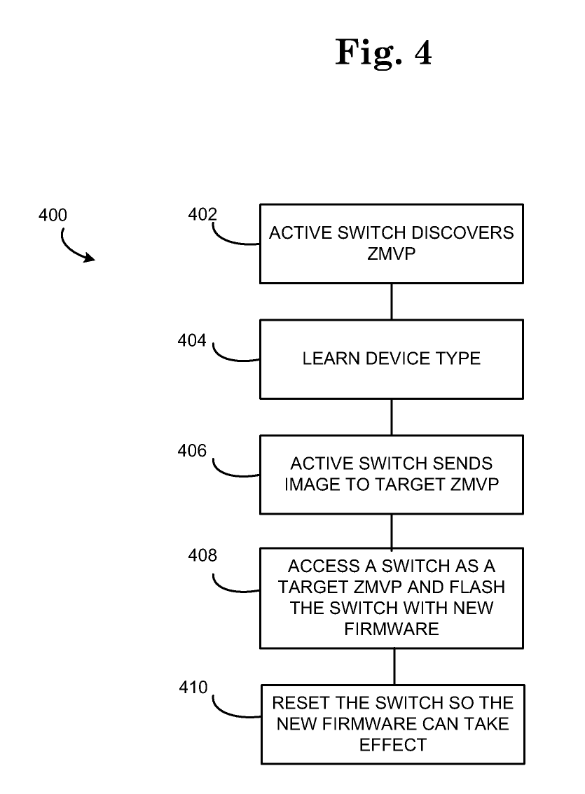

FIG. 4 illustrates a method 400, which can be an example of a particular aspect of method 300. The active SAS switch of the SAS fabric discovers ZMVPs in the SAS fabric with SMP commands such as SMP REPORT GENERAL and SMP DISCOVER LIST at 402. The active SAS switch determines that a discovered ZMVP is a ZMVP by sending it an SCSI INQUIRY command and inspecting the command response to learn the device type at 404. The active SAS switch executes a flash command by sending the contents of its embedded firmware image to a target ZMVP using the SCSI WRITE BUFFER command with mode 0x0E and buffer ID of 0x00 at 406. In the example, the target of the SCSI WRITE BUFFER command is the SAS address of the targeted ZMVP. When the targeted ZMVP receives the SCSI WRITE BUFFER Data, an interrupt fires on the SAS expander representing the ZMVP on the SAS fabric. In one example, the interrupt code also has access to a TCP/IP layer on the switch expander and forwards the command and the data on to a switch management module over a local Ethernet network or other mediumusing a proprietary command ID. This can be repeated multiple times with incremental buffer IDs to transfer and flash the entire ROM contents at 408. Upon completion of flashing, the active switch can perform a SCSI WRITE BUFFER command with mode 0x0F to reset the target SAS switch so that the new firmware can take effect at 410. When the ZMVP receives the SCSI WRITE BUFFER reset command, an interrupt fires on the SAS expander representing the ZMVP on the SAS fabric. In one example, switch software can be implemented on the expander and not via the Ethernet. In another example, the interrupt code can have access to a TCP/IP layer on the expander and forwards the command on to the switch management module over a local Ethernet network using a proprietary command ID. Upon receiving the command, the management module hard resets switches, which can also include the management module and the expanders.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of updating computer readable instructions on a plurality of devices in a data storage fabric, comprising:
granting an active device of the plurality of devices control of the data storage fabric by establishing a zone manager virtual phy, wherein the plurality of devices include in-band communication with the zone manager virtual phy; and
flashing an image of the computer readable instructions with the zone manager virtual PHY in-band to the plurality of devices through in-band communication with the active device.

2. The method claim 1 wherein granting an active device control of the data storage fabric includes granting a switch in the data storage fabric control of the data storage fabric.

3. The method of claim 2 wherein the data storage fabric includes a plurality of switches.

4. The method of claim 3 wherein the plurality of switches are trunked together.

5. The method of claim 1 wherein the storage fabric is a zone group.

6. The method of claim 1 wherein the flashing an image of the computer readable medium includes flashing an updated firmware.

7. The method of claim 6 wherein the flashing an updated firmware includes using a flash utility on the active device to flash a memory.

8. The method of claim 6 wherein an updated device of the plurality of devices includes an updated firmware, and further comprising flashing one of the plurality of devices with the updated firmware from the updated device.

9. The method of claim 1 wherein the data storage fabric is a version of a serial attached small computer system interface fabric.

10. A method of updating computer readable instructions on a plurality of devices in a data storage fabric, comprising:
granting a device of the plurality of devices control of the data storage fabric by establishing a zone manager virtual PHY, wherein the plurality of devices include in-band communication with the zone manager virtual PHY;
detecting a flash condition in the data storage fabric; and
flashing an image of the computer readable instructions with the zone manager virtual PHY through in-band communication to the plurality of devices.

11. The method of claim 10 wherein detecting a flash condition detecting one of plurality of devices in the data storage fabric has a firmware inconsistent with a ready firmware on the active device.

12. The method of claim 11 wherein the device having an inconsistent firmware is automatically flashed.

13. The method of claim 11 wherein the detecting the flash condition occurs when the device having inconsistent firmware is installed into the data storage fabric.

14. The method of claim 10 wherein the zone manager virtual PHY publishes itself as a target and an initiator.

15. The method of claim 10 wherein the zone manager virtual PHY flashes without out-of-band communication.

16. A system in a data storage fabric having a plurality of devices coupled together through in-band communication, the system comprising:
a zone manager virtual PHY configured to include in-band communication with the plurality of devices in the data storage fabric;
an active device having a memory, the active device configured to include in-band communication with the zone manager virtual PHY and the plurality of devices in the data storage fabric; and
computer readable instructions stored in the memory, wherein the active device is configured to update the plurality of devices through in-band communication with the zone manager virtual PHY with the computer readable instructions.

17. The system of claim 16 wherein the data storage fabric includes an initiator, a target, and an expander.

18. The system of claim 16 wherein the active device is switch in the data storage fabric.

19. The system of claim 16 wherein the zone manager virtual PHY includes a zone manager configured from a computing device.

20. The system of claim 19 wherein the zone manager is coupled to an Ethernet network and wherein at least some of the plurality of devices are not coupled to the Ethernet network.
